(19) United States
(12) Patent Application Publication
(10) Pub. No.: US 2018/0368382 A1
(43) Pub. Date: Dec. 27, 2018

(54) Construction Materials and Methods For Insect Monitoring

(71) Applicant: Bradley John Carpenter, Narangba, Queensland (AU)

(72) Inventor: Bradley John Carpenter, Narangba, Queensland (AU)

(21) Appl. No.: 16/063,452

(22) PCT Filed: Dec. 9, 2016
(86) PCT No.: PCT/AU2016/051215

§ 371 Date: Jun. 18, 2018

(30) Foreign Application Priority Data
Dec. 17, 2015 (AU) 2015905234

(51) Int. Cl. A01M 1/02

(52) U.S. Cl. CPC A01M 1/026; A01M 1/22; A01M 1/023

(57) ABSTRACT

The present invention provides an insect detection device configured to detect the presence of an insect in a building, the device comprising: a housing having insect entry means, internal insect attraction means disposed within the housing and accessible by an insect passing through the insect entry means, and an insect presence reporting means, wherein upon entry of one or more insects into the housing, the insect presence reporting means reports insect presence. The device may take the form of an architectural building feature such as a skirting board, and may be configured to detect the presence of termite species in particular.

### FIELD OF THE INVENTION

The present invention is directed to the monitoring, prevention and treatment of insect infestation of buildings. In particular, the invention is directed to materials used in building construction, modification, repair, and retrofitting; and furthermore methods for installing and utilizing such materials in insect control.

### BACKGROUND TO THE INVENTION

Infestation of buildings with insects is a significant consideration for building construction and maintenance. Termite infestation is a particular problem, with these insects being well known to cause significant property damage in many areas across the globe.

Termites are relentless in their search for food and regularly infest all manner of structures that utilize timber in construction. Homes, high rise concrete apartments, office blocks and other commercial buildings are often at risk. In extreme circumstances, entire housing developments have been demolished as a result of termite infestation.

After termites enter a building, infestation is usually discovered only after damage becomes obvious. Modern house construction provides an ideal combination of obscure access and significant food source. It is common for significant activity and consequent damage to be concealed behind walls that reveal no external evidence. By this stage, repair costs can be significant.

The risk of termite damage is significant, such that all new buildings and ground level extensions in Australia (and many other countries) are required to incorporate a physical barrier in construction. Products such as Termimesh™ and Kordon™ are often used. These barriers act to reduce the opportunity of termite entry around the external wall base. Despite the use of physical barriers many new homes have termite activity before occupancy. Indeed, manufacturers of termite barriers advise that termites may bridge even a properly installed barrier, and that ongoing inspections are important so as to minimise the risk of damage to a building.

A further consideration is that most physical barriers must be incorporated into the building during construction, retrofitting is generally not feasible.

Many approaches to preventing termite infestation rely on the impregnation of surrounding soil using one or more chemicals which behave as active or passive pesticides. For best practice, the full perimeter of the soil about a building is excavated to form a trench into which the chemicals are disposed. The trench is backfilled and treated, with the aim being to provide a complete and unbroken treatment zone. While generally effective, excavated trenching is expensive, and often prohibitively so for home owners. Furthermore, most commonly used chemicals have limited service life expectancy and require ongoing reapplication.

Lower cost procedures using liquid pesticide are known in the art. Rod injection is by far the most common form of termite protection provided by the pest control industry, and involves injecting liquid pesticide into regular spaced boreholes in the concrete abutments surrounding a building. Discontinuity of the pesticide barrier around the building perimeter is a significant problem with this approach.

Given the well accepted shortcomings of physical and chemical termite barriers, it is generally recommended that buildings are inspected at regular intervals in an effort to identify termite infestation as early as possible

Australian Standards recommend that regular inspections by a competent person should be performed at least every twelve months and advises that more frequent intervals of six months are appropriate. Typically, a visual inspection is carried out directed to all accessible areas inside the home, roof cavity, external perimeter and adjacent surrounds.

Visual inspections cannot assess inside cavity walls and are typically an unreliable means of detecting early stages of termite infestation. Subterranean termites are masters at covert entry and modern house construction provides an ideal combination of obscured access routes and large food source. It is therefore common for significant insect activity and damage to be concealed behind walls, with visual inspections failing due to the lack of any external evidence of the infestation.

The prior art provides various means to assist in the detection of termite infestation within a wall. Thermal imaging is often used as an adjunct to visual inspection; however the infrared cameras used do not allow visualization of the inside of a wall cavity. Instead, these devices simply reveal the disparity in temperature and are therefore may be easily confounded by materials having varying thermal coefficients, sunlight bearing on the external side of wall, and internal heating within the building for example.

Sophisticated multimodal systems are used to improve termite detection. For example, the Termatrac™ system includes radar means, a thermal sensor and moisture sensor the data from which is combined to identify termite infestation within a wall. While technologically advanced this system is expensive and relies on skilled calibration and implementation by well trained personnel. Even advanced systems such as Termatrac™ only provide evidence of relatively advanced activity and do not provide a direct means of assessing incipient stages of termite activity.

Visual inspections with or without adjunctive devices or systems rely on direct access to all parts of a building. Many high risk areas of a home cannot be assessed due to access difficulties including obstructions of furniture, fittings and other restrictions. For example, advanced damage of trusses and other roof timbers can be concealed by insulation.

In any event, visual inspections are in reality damage inspections which are capable of merely confirming that termites are already highly active inside a building. By that stage, the insects may have typically caused significant damage and the building owner is faced with substantial repair costs.

It is an aspect of the present invention to overcome and alleviate a problem of the prior art by providing an economical and effective alternative to prior art methods for the monitoring of termite entry. In the instance of termite infestation, the present invention further provides for the subsequent application of a treatment substance that is inadvertently transported back to the termite nest by the returning workers. This action results in the destruction of the invading termite colony.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides an insect detection device configured to detect the presence of an insect in a building, the device comprising: a housing having insect entry means, internal insect attraction means disposed within the housing and accessible by an insect passing through the insect entry means, and insect presence reporting means, wherein upon entry of one or more insects into the housing, the insect presence reporting means reports insect presence.

In one embodiment, the device is configured to be disposed at or about the floor level of a building.

In one embodiment, the device is configured to appear and/or function as an architectural feature of a building.

In one embodiment, the architectural feature is an internal architectural feature.

In one embodiment, the architectural feature is a skirting, a floor, a threshold, a step, a kickboard, a door frame, architrave, or a wall.

In one embodiment, the device comprises external insect attraction means disposed outside the housing.

In one embodiment, the external insect attraction means is configured to lead an insect from the exterior of the device, through the insect entry means, and toward the internal insect attraction means.

In one embodiment, the external insect attraction means comprises an insect traversable path which traverses the insect entry means.

In one embodiment, the internal insect attraction means, and/or external insect attraction means (where present) comprises an insect food or other attractant.

In one embodiment, the insect presence reporting means is configured to provide a visual report.

In one embodiment, the insect present reporting means comprises or consists of an insect viewing window.

In one embodiment, the insect viewing window is configured to provide a local temperature increase at or about the window so as to attract an insect to the window.

In one embodiment, the insect presence reporting means relies on insect disruption of the internal insect attraction means.

In one embodiment, the insect presence reporting means is biased toward a positive reporting state, the presence of the insect attraction means acting against the bias, wherein the insect attraction means is a solid consumable material and upon consumption thereof by an insect the insect presence reporting means reverts to the positive reporting state.

In one embodiment, the insect presence reporting means comprises electronic reporting means.

In one embodiment, the electronic reporting means comprises any one or more of camera means, sensor means, switch means, wired signal transmission means, or wireless signal transmission means.

In one embodiment, the device comprises an insect active agent contacting means configured to kill or inhibit an insect within housing.

In one embodiment, the pesticide contact means is an insect active agent entry port.

In a second aspect, the present invention provides a method for installing the as described herein comprising the step of attaching the device to a building part either during construction of a new building or during retrofitting to an existing building.

In one embodiment of the second aspect, the building part is a wall.

In one embodiment of the second aspect, the external insect attraction means (where present) contacts or is disposed about a wooden building frame member.

In one embodiment of the second aspect, the wooden building frame member is a bottom plate of an internal wall of the building.

In one embodiment of the second aspect, the external insect attraction means (where present) contacts or is disposed about soil adjacent the building.

### BRIEF DESCRIPTION OF THE DRAWINGS

FIG. 1 shows diagrammatically (in cross-sectional view) a preferred embodiment of the invention as installed on an internal wall of a building. This embodiment is configured as a skirting board.

FIG. 2 shows diagrammatically (in cross-sectional view) a preferred embodiment of the invention as installed on an external wall of a building. This embodiment is configured as external skirting.

FIG. 3 shows diagrammatically (in cross-sectional view) a preferred embodiment of the invention in unassembled form, and in assembled form. This embodiment is configured as a skirting board.

FIG. 4 shows a perspective view (“A”), a front lateral view (“B”) and a plan view (“C”) of a preferred embodiment of the invention, being in the form of a skirting board.

FIG. 5 shows diagrammatically (in plan view) a preferred insect reporting mechanism as disposed within a device of the invention, being a skirting board.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the finding that insects (and including termites) may be drawn into a hollow device which may be configured to be visually and/or functionally similar to an architectural feature of a building. Upon entry into the device, the presence of insects within the device is reported to a person such as the building occupant or a monitoring service. Accordingly, in a first aspect, the present invention provides an insect detection device configured to detect the presence of an insect in a building, the device comprising: a housing having insect entry means, internal insect attraction means disposed within the housing and accessible by an insect passing through the insect entry means, and insect presence reporting means, wherein upon entry of one or more insects into the housing, the insect presence reporting means reports insect presence.

Thus, the device acts to draw and report the presence of insects before any substantial damage is done to the building. This is a very different approach to the prior art which typically aims to detect (visually or electronically) either advanced infestations or the damage done by the insects.

In use, the device may be disposed at any place in or about a building as deemed suitable by the skilled person. However, it is preferred that the device is placed at lower level of the building such as at or about floor level (where the device is located internally), or at or about the level of the soil or any building abutment (where the device is located externally). Termites explore and select the most attractive timber then transport that food back outside to their underground nest. The most efficient delivery is achieved by short haul distance and typically the insects consume from the bottom of the building (i.e. closest to soil) first. Thus, the device may be placed on a floor or on an external abutment (such as a concrete abutment or a path) and may therefore have a substantially planar lower surface.

Furthermore, the device will be typically mounted against a wall (internal or external) and so the rear surface may also be substantially planar so as to achieve a flush fitting. In some embodiments the lower surface and the rear surface form substantially a right angle so as to fit into internal corner formed by a vertical surface (such as a wall) and a horizontal surface (such as a floor)

For the device intended to be visually inspected, it is preferred that placement is in an area that is frequently viewed in everyday usage of a building (such as an internal area away from furniture and fittings) such that deliberate inspection is not required. In any event, the device is placed in an area that is visually accessible.

Where a device does not require visual inspection (as described infra), further scope for placement is allowed for. For example, a device may be located behind furniture or even within a wall cavity.

Typically, the device will be substantially permanently affixed to the building in some manner and may be configured accordingly. For example, the housing may comprised a screw hole, a hook, a clip, a tab, an adhesive backing or the like to facilitate fixing.

Typically, the device would be fitted, either internally or externally, to the full linear perimeter of the building.

It is preferred that at least the housing of the device is formed from a material that is not consumable by a destructive insect such as a termite. The housing is intended to contain an insect drawn therein to some extent so as to prevent the easy spread of any infestation.

Accordingly, the housing at least may be fabricated from a synthetic material such as a polymeric material. Materials such as vinyls, acetates, styrenes, ethylenes and the like are typically suitable for the present devices.

In one embodiment the device is configured to as appear and/or function as an architectural feature of a building. Such devices are visually unobtrusive and can perform a dual function. For example, the device may be configured as a skirting so as to function as to (i) conceal the space formed about the lower edge of a plaster board wall and the floor surface, and also (ii) monitor for the entry of termites into the building. Increases in construction costs for termite monitoring may therefore be limited or completely avoided where the present devices are incorporated into a building during construction. Skirtings are particularly preferred because of the low-lying position of these features in a building. Termites entering the building from the underlying soil will typically be drawn to the lower timber frame members as food, and will tend therefore be drawn firstly toward soft timber skirtings. Accordingly, any infestation will more likely be detected in the very early stages and before any significant damage occurs.

Other architectural features that are near the floor are therefore also preferred such as a door frame (the lower regions of which may consist of or comprise a present device), a step (a stringer, a tread or a riser may consist of or comprise a present device), or even the floor itself (the device may be finished with the same material as the floor so as to be rigid and visually unobtrusive).

The device may also be configured as an external architectural feature, or may be configured as a garden edging which abuts the external wall of a building. In these embodiments, the visual obtrusiveness of the device may be less important than as for an internal application.

A function of the present device is to attract insects into the device so as to be detected by the insect presence reporting means. Accordingly, the device comprises insect entry means. Typically the insect entry means will be positioned on the device on or about a device surface which is likely to face an invading insect. Where the device is configured as a skirting, for example, the entry means will preferably be located on the rear face (i.e. the surface facing the wall) such that insects attracted to the lower timber frame members within the wall cavity can access the entry means. In this embodiment, the entry means typically extends through the wall cladding (such as drywall/plaster board) and into the wall cavity so as to provide a conduit between the wall cavity and the device housing interior. Thus, the entry means may comprise a tube or similar contrivance capable of conveying and guiding the insects toward the device interior.

The entry tubes may incorporate a cellulose barrier/blockade within the tube tunnel, thus access through the tube is denied to other insects such as ants. In such configuration entry to the skirting device requires removal of the high food value barrier plug by process of termite ingestion. This ensures that the sealed skirting device is not contaminated over time by any other insect or substance that may deter termite infestation within.

In other embodiments, the entry means may simply be an aperture sized so as to allow an insect to pass. For example, where the device is incorporated into a door frame the entry means may directly face the wall cavity and so a conduit is not required.

Generally, the housing is substantially sealed with the exception of the unblocked entry means. Termites will utilize the same access tubes to exit the device and establish a regular cycle of food transport outside to their underground nest. It is this instinctive cycle activity of the food gathering workers that delivers the toxin (administered as a single dose at peak cycle to termites feeding within the device) back to the colony nest location.

The device comprises insect attraction means disposed internal to the housing, the function of which is to bring insects into the device and to the insect presence reporting means. Preferably the insect attraction means is more attractive than the building timbers such that any termites entering the building will preferentially enter the device rather than destroy surrounding timbers.

The insect attraction means may be simply a portion of wood for which the target insect species has a known attraction. For example, Nasutitermes exitiosus (common in Southern Queensland and southern Australian states) has a preference for the sapwood of hardwood species. Other termite species have preferences for timbers of pine, karri, marri, mountain ash, meranti and even particle board. Given the specie(s) of concern, the skilled person is enabled to select and appropriate species of wood to act as an attractant.

The skilled person will be familiar with a range of more complex insect attractants useful in the context of the present devices. Cellulose-based agents are known to be attractive to termites. For example, the attractant may be a portion of high energy timber that has been further enhanced by pre-treatment with refined cellulose. Carbohydrates such as cellulose, starch and sugar may be enhanced by soaking timber bait portions in immersion trays. The solution is absorbed into the timber and remains impregnated when the strips are removed and dried.

Termites may be attracted toward partially rotted wood because the brown rot fungus produces the termite aggregation pheromone (Z,Z,E)-3,6,8-dodecatrien-1-ol. Hydroquinone and amino acids have also been used as attractants. Glycol ethers can act as trail pheromones.

The attractant may be gas (such as carbon dioxide), which is known to attract insects.

There are several thousand different termite species around the world and while hazard to construction timbers varies substantially with species there are numerous varieties that pose a major commercial threat. Most subterranean varieties share common process however different species may exhibit a diverse preference in food attraction. It is intended that the bait food attractant installed within the present device may be selected for preference qualities and/or improved by additional enhancement means to best target the species intended. In essence the objective is to provide a higher value attractant, within the device and the entry apertures, than surrounding construction timbers to ensure that termites consume this preference on initial building entry.

In a preferred embodiment, the attractant is efficacious in respect of an insect that is liable to cause damage to a building, or to otherwise infest a building. In one embodiment the attractant has efficacy for a termite species, and optionally against any of the following Australian species: Mastotermes, Coptotermes, Schedorhinotermes, Heterotermes, Microceroterme.

Typically, the attractant draws large numbers of insects to repeated feedings within the device so as to facilitate detection and mass local aggregation. Thus, the attractant may be devoid of a repellent or a pesticidal activity.

In some embodiments, the attractant extends outside the device, and/or a separate attractant is disposed outside the device. Such external attractants function to attract and guide the insects toward attractant within the housing.

Generally, the external attractant will be configured so as to lead insects toward the entry means. The external attractant may be separate to the device, with the device further comprising a physical or chemical path between the external attractant and the entry means to guide the insects toward the entry means.

In one embodiment, the entry means is also an external attractant. For example, the entry means may be a cellulose tube treated with an enhancement substance. The insects are attracted to feed within the tube an eventually find their way to the larger amounts of internal attractant disposed within the device.

In other embodiments, the external attractant is configured so as to contact a timber frame member of the building such that termites attracted to feed on the timbers move toward the external attractant and then into the device. Such an embodiment may comprise a high value food material attached to the entry portals by a flexible connecting means. Thus, insects attracted to the external attractant continue toward the entry portal via the connecting means. The connecting means provides for some spatial flexibility in placing the external attractant on the frame timber.

The device comprises an insect presence reporting means configured to allow a person or an electronic contrivance (such as a microprocessor) to recognise or sense the presence of one or more insects in the device. In simple form, the reporting means be a window allowing for the visual inspection of the interior of the device. Typically, the window will be dimensioned and positioned so as to allow viewing of one or more insects on, about, or consuming the internal attractant.

It will be appreciated that the housing may have considerable internal volume, and so it is possible that insects may be present within the device but not easily viewable. In this regard, the window may be advantageous given that a localised heating about the window may occur, with the heat drawing termites to the window. Although termites are blind they are very sensitive to thermal change and tend to move toward regions of warmth. The window may be comprised on of a thermally conductive material (such as a glass) such that the elevated temperature of the room may preferentially warm the window. Alternatively, the window may provide a greenhouse effect when exposed to light so as to provide localised warming. As a further option, the window material may be configured to refract light such that an area of higher temperature is created around the widow edge.

It is still possible that insects may not be directly viewable through the window. However, it is known that termites will lay down an opaque mud layer over a light source with the presence of this layer being indicative of termite activity within the device.

As an alternative or adjunctive to a viewing window, various mechanical, electrical and electronic reporting systems are useful in the present invention. As one example, a spring-actuated indicator could be used, with the physical destruction of a food portion by termites releasing the spring so as to actuate a mechanical flag. The released spring may activate a micro switch thereby completing an electrical circuit so as illuminate an indicator light. As another alternative, the micro switch may close a micro a circuit detectable by a microprocessor, with the microprocessor transmitting a signal wirelessly (such as via WiFi™) to a monitoring computer. Other electronic reporting means include a camera (optical or infrared), or a microphone.

Once a population of insects has been attracted to the housing and the infestation thereby detected, it will typically be desired to exterminate any insects within the housing and also preferably any insects outside the housing but of the same nest. Thus, means for introducing a gas, or a liquid, or a solid, or a suspension or a dusting of an insect active compound may be incorporated in the present device.

Typically, termite numbers are allowed to increase as they establish optimum feeding cycle then they are “dusted” in place. Small front covers at either end of the device can be opened to reveal injection valves and a low pressure application of toxin is circulated within the hollow interior. The treatment apparatus regulates introduction of a fine dust that adheres to the bodies of termites feeding inside. It also provides subtle disturbance of warm air and pressure change that causes all termites to evacuate and return to the security of their nest. Inadvertently they deliver a lethal dose that results in the collapse of the entire colony.

The quantity of toxin applied is minute and this is the only period that any hazard is present within the sealed system. While this presents no danger to occupants, the front cover may be fitted with warning stickers and a locking device that cannot be opened without key. It is therefore not possible for children or inquisitive others to gain exposure to any toxic residue.

Generally the device is left untouched for about seven days after treatment at which time the device is; cleaned, restocked with fresh attractant and reset to monitoring mode.

The present invention will now be more fully described by reference to the following non-limited examples.

### DETAILED DESCRIPTION OF PREFERRED EMBODIMENTS

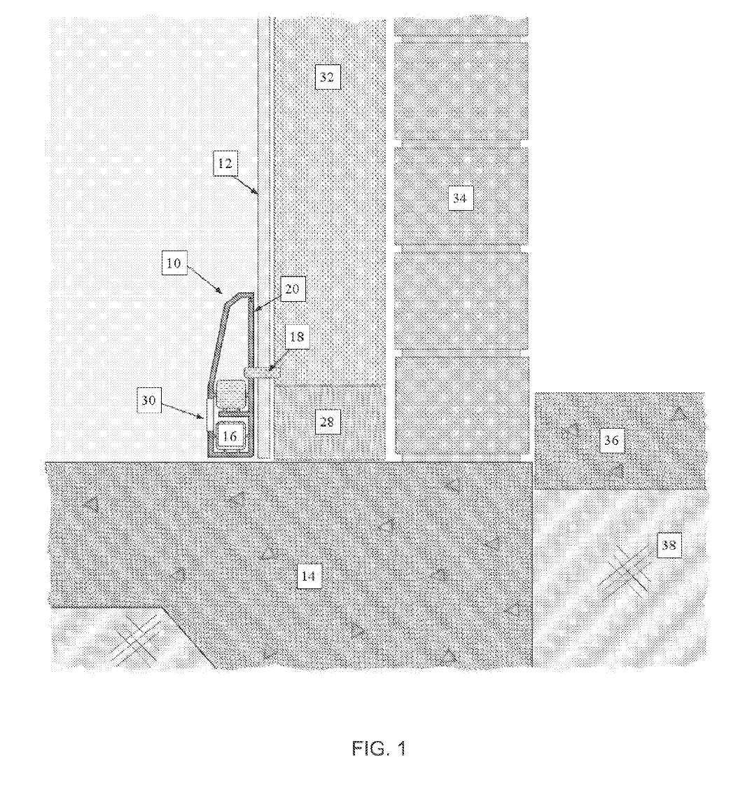

Turning firstly to FIG. 1 there is shown a preferred monitoring device configured as a hollow skirting board 10 similar to conventional baseboard and suitable for use as cosmetic internal wall trim in a building. The device is applied against the plasterboard/drywall 12, and above the concrete slab floor 14. The skirting board 10 comprises lengths of bait strip (one marked as 16) which may have been enhanced by a pre-treatment process. The high energy bait strips 16 provide a superior food source than other construction timbers and act as an internal attractant to termites. The entry tunnel 18 traverses the rear plate 20 of the skirting board 10 and also the adjacent plasterboard wall 12.

In the process of installation, a hole is drilled through the wall 12 to allow insertion of the entry tunnel 18 that is made of the same bait wood attractant as 16. Accordingly, termites travelling along the bottom plate 28 are attracted to the to the entry tunnel 18. Once inside the skirting board 10, the insects feed on the internal wood attractant 16 and transport this high energy food back outside to the colony nest. Over time, more and more insects accumulate within the skirting board 10 and are visible through the widow 30.

For orientation, FIG. 1 shows the position of a vertical internal stud 32, the external building wall 34 and an external concrete abutment 36.

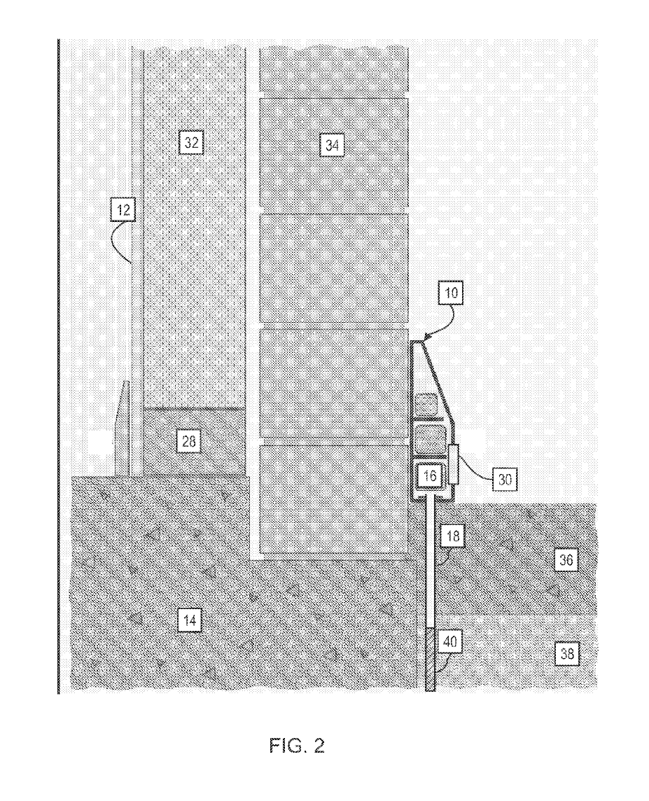

FIG. 2 shows an external skirting board similar to that shown in FIG. 1 as applied to an external wall 34. A conventional internal skirting board is shown as 39. The wall has an external concrete abutment 36 flush with the wall 34 and the foundation slab 14. This embodiment comprises a hollow tube 18 as the entry tunnel, to which a high energy bait food attractant 40 is attached. During installation, a hole is drilled through the abutment 36 and into the underlying soil 38. The tube 18, and the attractant 40 are inserted into the hole so that the attractant 40 contacts the soil 38. This embodiment is used to attract termites directly from the soil into the external mounted skirting board 10.

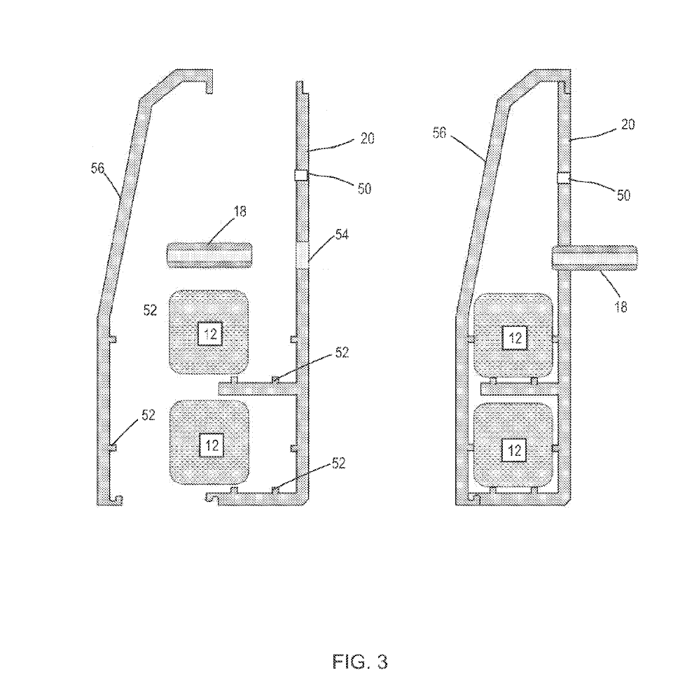

FIG. 3 shows an exemplary skirting board in cross section detail. The unassembled view on the left shows the backing plate 20 having screw holes 50 for attachment to the wall. The backing plate 20 comprises an aperture 52 for insertion of the tunnel 18 therethrough. The front cover plate is shown as 53 and the viewing window is shown as 30.

Once the backing plate 20 is screwed to the wall, the tunnel 18 is inserted into the aperture 52 and through the wall lining (via a predrilled hole) to communicate with the wall cavity. The front plate 53 of the skirting board is snapped onto the backing plate, as shown in the right hand drawing.

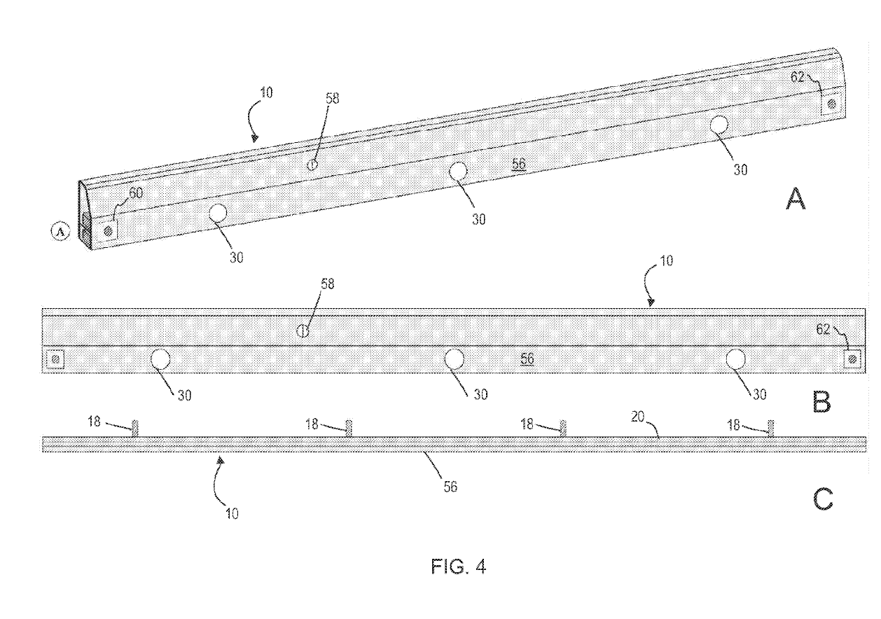

FIG. 4 shows a length of skirting board device revealing a number of viewing windows 30 disposed along the front plate 53.

Ports to introduce 54 and exhaust 55 insecticidal agents are disposed at the respective ends of the skirting board. The ports are openable and closable valve means and allow for the introduced agent to be contained within the skirting device until extraction via the exhaust port 55 into a receiving vessel.

The plan view C reveals multiple tunnels 18 extending from the rear plate 20. The multiple tunnels are positioned to coincide with vertical wall stud spacings to connect each individual wall cavity to the preferred bait food contained within the skirting device. Thus, termites are provided with regularly spaced tunnels to increase the probability that the insects will accumulate within the skirting device rather than consume less attractive construction timbers.

A physical termite activity warning indicator fitted to the front panel 53 is shown as 65.

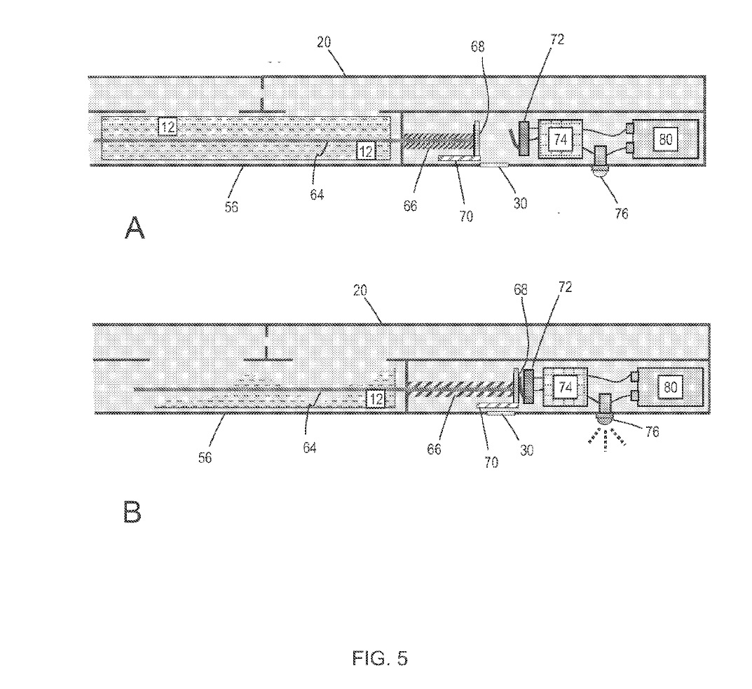

FIG. 5 shows a preferred reporting means as disposed within a skirting board device. The internal cellulose retention attractant 60 comprises a push bar 61, with the spring 62 being retained in a compressed state by the association of the attractant 60 to the push bar. The push bar 61 is connected to a plate 63, with an indicator flag 64 being attached in turn to the plate 63. The upper drawing shows the reporting means in a negative state whereby an indicator flag 64 is not viewable through the viewing window 65.

The lower drawing of FIG. 5 shows the reporting means in a positive state (i.e. reporting a termite infestation) whereby the termites have consumed a significant proportion of the attractant 60. The push bar 61 is no longer retained by the attractant, and the spring 62 has expanded so as to push the plate 63 rightwards, to thereby move the indicator flag 64 such that it becomes viewable through the window 65. Thus, a person checking the window 65 would see the indicator flag thereby warning that a termite infestation is present.

In this embodiment, the plate 63 also actuates the electronic micro switch 66. Closing of the switch 66 is sensed by the microprocessor with radio module 67 and a signal transmitted by the radio transmitter function. A LED 68 is also activated to draw attention to the infestation. The electronics may be powered by a battery 69.

The present disclosure is directed to methods for controlling termites, however it will be understood that applicability to other insects in contemplated. Given the benefit of the present specification, the skilled person is adequately enabled to select an active agent for use with any other insect species. Such embodiments are included in the ambit of the present invention.

The invention may be said broadly to consist in the parts, elements and features referred to or indicated in the specification of the application, individually or collectively, in any or all combinations of two or more of said parts, elements or features. Wherein the foregoing description reference has been made to integers or components having known equivalents thereof, those integers are herein incorporated as if individually set forth.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art.

It will be appreciated that in the detailed description and the description of preferred embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby expressly incorporated into this description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art. For example, in the claims appended to this description, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

It is not represented that any embodiment of the invention provides all, or even most advantages described herein. Some embodiments my provide no advantage whatsoever, and may merely represents a useful alternative to the prior art.

1. An insect detection device configured to detect the presence of an insect in a building, the device comprising:
a housing having insect entry means,
internal insect attraction means disposed within the housing and accessible by an insect passing through the insect entry means, and
an insect presence reporting means, wherein upon entry of one or more insects into the housing, the insect presence reporting means reports insect presence.

2. The insect detection device of claim 1 configured to be disposed at or about the floor level of a building.

3. The insect detection device of claim 1 configured to appear and/or function as an architectural feature of a building.

4. The insect detection device of claim 2 wherein the architectural feature is an internal architectural feature.

5. The insect detection device of claim 2 wherein the architectural feature is a skirting, a floor, a threshold, a step, a kickboard, a door frame, an architrave, or a wall.

6. The insect detection device of claim 1 comprising external insect attraction means disposed outside the housing.

7. The insect detection device of claim 6 wherein the external insect attraction means is configured to lead an insect from the exterior of the device, through the insect entry means, and toward the internal insect attraction means.

8. The insect detection device of claim 7 wherein the external insect attraction means comprises an insect traversable path which traverses the insect entry means.

9. The insect detection device of claim 6 wherein the internal insect attraction means, and/or external insect attraction means comprises an insect food or a chemical attractant.

10. The insect detection device of claim 1 wherein the insect presence reporting means is configured to provide a visual report.

11. The insect detection device of claim 10 wherein the insect present reporting means comprises or consists of an insect viewing window.

12. The insect detection device of claim 11 wherein the insect viewing window is configured to provide a local temperature increase at or about the window so as to attract an insect to the window.

13. The insect detection device of claim 1 wherein the insect presence reporting means relies on insect disruption of the internal insect attraction means.

14. The insect detection device of claim 13 wherein the insect presence reporting means is biased toward a positive reporting state, the presence of the insect attraction means acting against the bias, wherein the insect attraction means is a solid consumable material and upon consumption thereof by an insect the insect presence reporting means reverts to the positive reporting state.

15. The insect detection device of claim 1 wherein the insect presence reporting means comprises electronic reporting means.

16. (canceled)

17. The insect detection device of claim 1 comprising an insect active agent contacting means configured to kill or inhibit an insect within housing.

18. (canceled)

19. A method for installing an insect detection device of comprising
providing the insect detection device, which is configured to detect the presence of an insect in a building, the device comprising:
a housing having an insect entry,
internal insect attraction means disposed within the housing and accessible by an insect passing through the insect entry, and
an insect presence reporting means, wherein upon entry of one or more insects into the housing, the insect presence reporting means reports insect presence
attaching the insect detection device to a building part either during construction of a new building or during retrofitting to an existing building.

20. The method of claim 19 wherein the building part is a wall.

21. The method of claim 19 wherein the insect detection device comprises external insect attraction means, and wherein the method comprises contacting the external insect attraction means with a wooden building frame member, or disposing the external insect attraction means about a wooden building frame member.

22. (canceled)

23. The method of claim 19 wherein the insect detection device comprises external insect attraction means, and wherein the method comprises contacting the external insect attraction means with soil adjacent the building or disposing the external insect attraction means about soil adjacent the building.
